(19) United States
(12) Patent Application Publication
(10) Pub. No.: US 2018/0165623 A1
(43) Pub. Date: Jun. 14, 2018

(54) METHOD AND SYSTEM FOR LOAD BALANCING OF CARE REQUESTS FOR WORKLOAD MANAGEMENT

(71) Applicant: KONINKLIJKE PHILIPS N.V., EINDHOVEN (NL)

(72) Inventors: Matthew Len LEE, New York, NY (US); Mladen MILOSEVIC, Stoneham, NY (US); Portia E. SINGH, Everett, NY (US)

(21) Appl. No.: 15/580,441

(22) PCT Filed: Jun. 8, 2016
(86) PCT No.: PCT/IB2016/053341

§ 371 Date: Dec. 7, 2017

Related U.S. Application Data
(60) Provisional application No. 62/173,079, filed on Jun. 9, 2015.

(51) Int. Cl. G06Q 10/06; G06Q 50/22

(52) U.S. Cl. CPC G06Q 10/063114; G06Q 50/22; G06Q 10/063112

(57) ABSTRACT

A system and method to provide a care-based activity recommendation engine are described. The system comprises electronic storage and physical computer processors. The electronic storage stores care recipient profile information for the care recipient including information related to care needs of the care recipient and caregiver profile information including schedule information, resource information, relationship information, or location information for individual caregivers. The processor(s) are in operative communication with the electronic storage and are configured to obtain activity tasks about the care recipient. The processor(s) determine likelihood metric values for the individual caregivers for given activity tasks indicating capacity and/or likelihood of a given caregiver to perform a given activity task. The processor(s) communicate the individual activity task to the individual caregiver responsive to the likelihood metric values indicating that the individual caregiver has the capacity and/or likelihood to complete the individual activity task.

### BACKGROUND

### 1. Field

The present disclosure pertains to a method and system for load balancing of care requests for workload management. The system and method provide improved distribution of activity tasks related to care recipients and their caregivers including family members, friends, and/or medical professionals.

### 2. Description of the Related Art

Typical methods of load care balancing involve a central caregiver that manages care and makes individual requests for help from supportive caregivers. In addition to providing the basic needs of the care recipient, the central caregiver may need to ensure that the care recipient complies with specific medical professional instructions, manage financial obligations, and/or have other duties and obligations. The current methods for coordinating the delegation and reporting of care tasks/appointments include telephone conversations, email, face-to-face conversation, paper-based calendars, post-it notes, and refrigerator notes. Though these methods have been a means to an end for a long time, the methods may over burden the central caregiver. Point-to-point communication methods relay information from one person to another (e.g., telephone calls). If the receiver of the information (e.g., a supportive caregiver) is unable to complete the requested task the central caregiver must either identify another capable person or do the task him/herself. Because the need remains, the central caregiver must at a minimum request another supportive caregiver to help and explain what needs to be done. As such, the central caregiver may be required to phone multiple friends and relatives to coordinate care.

### SUMMARY

Accordingly, one or more aspects of the present disclosure relate to a system configured to provide a care recipient care-based activity recommendation engine. The system comprises electronic storage and one or more physical computer processors. The system is configured to store care recipient profile information for the care recipient in a care recipient profile associated with the care recipient. The care recipient profile information includes information related to the care needs of the care recipient. The system stores caregiver profile information for two or more caregivers. The caregiver profile information includes one or more of schedule information, resource information (e.g., including a caregiver's skills and/or capabilities), relationship information, location information, and/or other information for individual caregivers. The caregiver profile information includes first caregiver profile information stored in a first caregiver profile for a first caregiver and second caregiver profile information stored in a second caregiver profile for a second caregiver. The one or more physical computer processors are in operative communication with the electronic storage and are configured by computer readable instructions to obtain activity tasks about the care recipient. The activity tasks are performed to care for the care recipient. The activity tasks have associated activity information. The activity information indicates one or more of an estimated time commitment, an activity task type, or required caregiver resources for a given activity task. The activity tasks include a first activity task having first activity information and a second activity task having second activity information. The processors may generate a queue of activity tasks for the care recipient based on the activity information and the care recipient profile and determine likelihood metric values for the one or more caregivers and the activity tasks in the queue. A likelihood metric value of the likelihood metric for a given caregiver and a given activity task indicate capacity and/or likelihood of the given caregiver to perform the given activity task. The likelihood metric values are determined based on activity information for the individual activity tasks and the profile information in the individual caregiver profiles. The likelihood metric values include a first likelihood metric value for the first caregiver and the first activity task, and a second likelihood metric value for the second caregiver and the first activity task. Responsive to the likelihood metric values indicating that the individual caregiver has the capacity and/or likelihood to complete the individual activity task, the processor(s) communicate the individual activity task to the individual caregiver such that, responsive to the first likelihood metric value indicating that the first caregiver has the capacity and/or likelihood to complete the first activity task, the first activity task is communicated to first caregiver, and, responsive to the second likelihood metric value indicating that the second caregiver has the capacity and/or likelihood to complete the second activity task, the second activity task is communicated to the second caregiver.

Yet another aspect of the present disclosure relates to a method for providing a care recipient care-based activity recommendation engine with a recommendation system. The system comprises electronic storage and one or more physical computer processors. The method comprises storing care recipient profile information in electronic storage. The care recipient profile information for the care recipient is stored in a care recipient profile associated with the care recipient. The care recipient profile information includes information related to care needs of the care recipient. The method comprises storing caregiver profile information in electronic storage, including caregiver profile information for two or more caregivers. The caregiver profile information includes one or more of schedule information, resource information (e.g., including a caregiver's skills and/or capabilities), relationship information, or location information for individual caregivers. The caregiver profile information includes first caregiver profile information stored in a first caregiver profile for a first caregiver and second caregiver profile information stored in a second caregiver profile for a second caregiver. The method comprises obtaining, with the one or more physical computer processors, activity tasks about the care recipient. The activity tasks are performed to care for the care recipient. The activity tasks have associated activity information. The activity information indicates one or more of an estimated time commitment, an activity task type, or required caregiver resources for a given activity task. The activity tasks include a first activity task having first activity information and a second activity task having second activity information. The method comprises generating a queue of activity tasks for the care recipient based on the activity information and the care recipient profile, and determining likelihood metric values for the one or more caregivers and the activity tasks in the queue. The likelihood metric value for a given caregiver and a given activity task indicate capacity and/or likelihood of the given caregiver to perform the given activity task. The likelihood metric values may be determined based on activity information for the individual activity tasks and the profile information in the individual caregiver profiles. The likelihood metric values include a first likelihood metric value for the first caregiver and the first activity task, and a second likelihood metric value for the second caregiver and the first activity task. The method comprises, responsive to the likelihood metric values indicating that the individual caregiver has the capacity and/or likelihood to complete the individual activity task, communicating, with the one or more processors, the individual activity task to the individual caregiver such that, responsive to the first likelihood metric value indicating that the first caregiver has the capacity and/or likelihood to complete the first activity task, the first activity task is communicated to first caregiver, and, responsive to the second likelihood metric value indicating that the second caregiver has the capacity and/or likelihood to complete the second activity task, the second activity task is communicated to the second caregiver.

Still another aspect of the present disclosure relates to a system configured to provide a care recipient care-based activity recommendation engine. The system comprises means for storing care recipient profile information for the care recipient in an electronic care recipient profile associated with the care recipient. The care recipient profile information includes information related to care needs of the care recipient. The system comprises means for electronically storing caregiver profile information for two or more caregivers. The caregiver profile information includes one or more of schedule information, resource information (e.g., including a caregiver's skills and/or capabilities), relationship information, or location information for individual caregivers. The caregiver profile information includes first caregiver profile information stored in a first caregiver profile for a first caregiver and second caregiver profile information stored in a second caregiver profile for a second caregiver. The system comprises means for obtaining activity tasks for the care recipient. The activity tasks are performed to care for the care recipient. The activity tasks have associated activity information. The activity information indicates one or more of an estimated time commitment, an activity task type, or required caregiver resources for a given activity task. The activity tasks include a first activity task having first activity information and a second activity task having second activity information. The system comprises means for generating a queue of activity tasks for the care recipient based on the activity information and the care recipient profile, and means for determining likelihood metric values for the one or more caregivers and the activity tasks in the queue. A likelihood metric value for a given caregiver and a given activity task indicates capacity and/or likelihood of the given caregiver to perform the given activity task. The likelihood metric values may be determined based on activity information for the individual activity tasks and the profile information in the individual caregiver profiles. The likelihood metric values include a first likelihood metric value for the first caregiver and the first activity task, and a second likelihood metric value for the second caregiver and the first activity task. Responsive to the likelihood metric values indicating that an individual caregiver has the capacity and/or likelihood to complete an individual activity task, means for communicating the individual activity task to the individual caregiver communicates the individual activity task such that, responsive to the first likelihood metric value indicating that the first caregiver has the capacity and/or likelihood to complete the first activity task, the first activity task is communicated to first caregiver, and, responsive to the second likelihood metric value indicating that the second caregiver has the capacity and/or likelihood to complete the second activity task, the second activity task is communicated to the second caregiver.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1 schematically illustrates a system configured for load balancing of care requests for workload management;

FIG. 2 illustrates exemplary activity task assignments made to individual caregivers; and

FIG. 3 illustrates a method for load balancing of care requests for workload management.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Caregiving can be a time consuming activity. For example, caregivers may spend 20 or more hours on average providing care per week. This care may include help with both activities of Daily Living (ADLs) and Instrumental Activities of Daily Living (IADLs). IADLs that are supported by unpaid caregivers may include transportation (both driving and arranging), housework, grocery shopping, meal preparation, finance management, administering medication, arranging for paid services (e.g. home nurses, meals on wheels), and/or other activities. Managing these activities for a loved one while also managing one's own household can become a great burden. Moreover, the “sandwich generation” who care for children at home while also caring for an ill parent face an even greater burden.

Often times, multiple caregivers help to provide and manage the care. For example in a family with three siblings the first sibling may live closest to the loved one and therefore may take on the responsibility of emergencies and medication administration. The second sibling may live relatively close-by but may have a full-time job during the week. But the second sibling may provide care of routine household activities during the weekend. The third sibling may reside in a different state and may not be able to help with daily care. However, the third sibling may contribute remotely by managing finances, arranging for paid services, and/or providing moral support to the other siblings. Neighbors, family friends, and/or others may provide occasional assistance with one or more activity tasks (e.g. landscaping, transportation, and/or meals).

Examples that include a first caregiver and/or a second caregiver are used throughout the specification and claims (described below). It should be noted that this is not intended to be limiting. System 10 is configured to function as described herein for a care recipient and/or any number of caregivers.

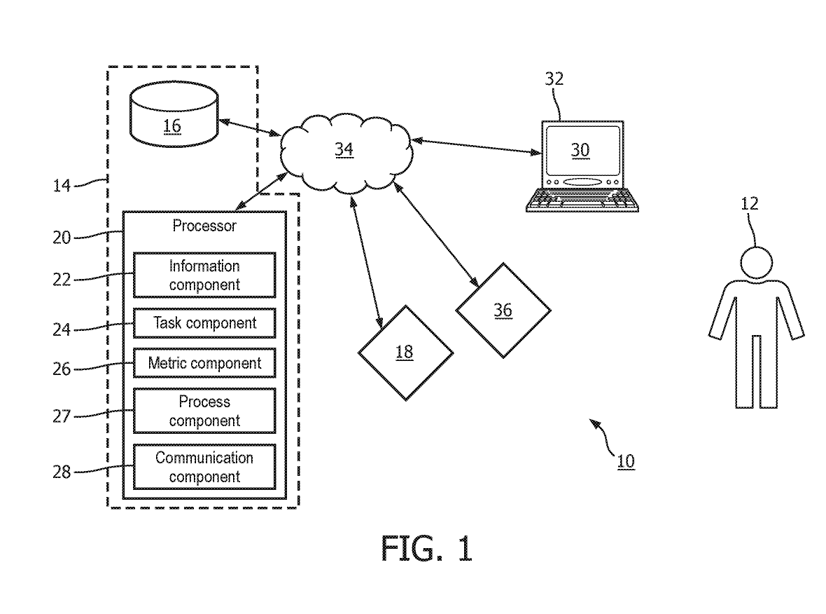

FIG. 1 illustrates a system 10 configured to provide a care recipient care-based activity recommendation engine. System 10 generates care recommendations and/or notifications and distributes them to caregivers, which may enhance care recipient care, improve communication between caregivers, relieve caregivers of the burden of managing and/or coordinating care, improve communication between caregivers, and/or perform other functions, in accordance with one or more embodiments. Caregivers may include friends of a care recipient, family members of a care recipient, doctors, nurses, and/or other users associated with a care recipient. For example, system 10 may be configured to generate and/or provide activity requests to a care recipient and/or a caregiver to improve care received by the care recipient, to lighten the burden on a single primary caregiver, to improve the communication between the care recipient and the caregiver(s), and/or for other purposes. In some embodiments, system 10 may be configured to share information regarding activities involving one caregiver with another caregiver. In some embodiments, system 10 may be configured to monitor, track, and/or quantify activity of one or more caregivers and the activity tasks in a queue. In some embodiments, system 10 may be configured to monitor, track, and/or quantify interactions between caregivers. In some embodiments, system 10 may be configured to generate recommendations and/or notifications that enhance communications between caregivers that support relationships and/or otherwise build affinity. For example, system 10 may be configured to share information regarding activities of a particular caregiver living alone (or mostly alone) with a family member who cannot be physically present with the particular caregiver every day. By sharing information and actively and/or passively providing activity requests as described in this disclosure, the interactions between the particular caregiver and the family member may be improved (e.g. more frequent, more positive, more reciprocal, more engaging, more supportive, and/or otherwise improved). In some embodiments, system 10 may be configured to facilitate communication between caregivers.

In some embodiments, system 10 identifies needs of a care recipient 12 and generates corresponding activity tasks, then finds caregivers with time and resources to complete one or more of the activity tasks. In some embodiments, system 10 is configured such that care recipient 12 and/or one or more of the caregivers manually generate the activity tasks. For example, identifies needs and generating corresponding activity tasks may include obtaining one or more activity tasks manually generated (e.g., entered, selected, emailed, texted, etc. via an associated computing device) by the care recipient and/or one or more caregivers. The needs of care recipient 12 include activity tasks that may be one or more projects or responsibilities of care recipient 12. Caregivers perform activity tasks to meet one or more needs, wants, and/or requirements of care recipient 12. System 10 may manage digital calendars and enable smartphone connectivity to determine an individual caregiver's location and/or the caregiver's current ability to complete an activity task. System 10 may use circles to assess individual caregiver workloads and/or provide tailored care activities to individual caregivers within the circle. Caregivers can be divided into circles (e.g., family, close friends, friends, neighbors, associates, and/or others) to determine if a particular activity task is appropriate for that circle. A family or medical professional circle, for example, may be more willing to dress an infected wound whereas a neighbor may be willing to make and deliver a dinner. System 10 may recommend caregiver activities based on the caregivers abilities and/or suggested activities that fit into the caregiver's schedule. System 10 may provide awareness to other caregivers within the circle (and/or circles) when an individual caregiver (e.g. a central caregiver) becomes overwhelmed. Multiple people seeking to accomplish multiple activity tasks may require careful coordination. The coordination may become more stressful when related to a loved one that is reliant on the activity tasks for personal wellbeing and health. The system provides support to a caregiver circle (e.g. group of related caregivers) to ensure that tasks are assigned and/or completed.

System 10 may include one or more networks 34, one or more physical computer processors 20 configured to execute computer program components, one or more client computing platforms 32 with user interfaces 30, electronic storage 16, one or more sensors 18, external resources 36, and/or other components. System 10 is configured to provide care recipient 12 a care-based activity recommendation engine 14 to enable load balancing (e.g., communicating activity tasks to caregivers so that one individual care giver is not overwhelmed) for caregivers assisting care recipient 12. The computer program components may include an information component 22, a task component 24, a metric component 26, a communication component 28, and/or other components.

As is shown in FIG. 1, system 10 may operate in communication and/or coordination with one or more external resources 36 and/or computing platforms 32. Caregivers may interface with system 10 and/or external resources 36 via user interfaces 30 of the client computing platforms 32. The components of system 10 may be operatively linked via one or more electronic communication links. For example, such electronic communication links may be established, at least in part, via a network 34 such as the Internet and/or other (communication) networks. It will be appreciated that this is not intended to be limiting, and that the scope of this disclosure includes embodiments in which components may be operatively linked via some other communication media.

Electronic storage 16 is configured to store care recipient profile information, caregiver information, activity tasks (described below), an activity task queue (described below), and/or other information. Care recipient profile information includes schedule data related to appointments of care recipient 12, treatment schedules of care recipient 12, needs of care recipient 12, health records for care recipient 12, insurance information for care recipient 12, and/or other information related to care recipient's 12 needs. Caregiver information includes schedule information, resource information (e.g., whether or not a caregiver owns a car/lawnmower/etc., whether or not a caregiver has medical equipment, financial resources, specific skills and/or capabilities, etc.), relationship information (e.g., how is the caregiver related to care recipient 12), historical information (how has the caregiver previously helped care recipient 12), location information (how far away is the caregiver from care recipient 12), and/or other information for individual caregivers. Electronic storage 16 obtains care recipient profile information and/or caregiver profile information from user interface 30, sensors 18, external resources 36 (e.g., databases, the world-wide web, and other data sources), and/or other locations of information. Electronic storage 16 stores care recipient profile information for a care recipient 12 in an electronic care recipient profile associated with care recipient 12. The care recipient profile information includes information related to the care needs of care recipient 12 and/or other information. For example, electronic storage 16 may include health insurance information, allergy information, blood type, DNA information, and/or other personal health data related to care recipient 12. Care recipient profile information may include schedule data related to appointments of care recipient 12 and/or treatment schedules of care recipient 12. Electronic storage 16 may store information related to care recipient 12 obtained via user interface 30, one or more sensors 18, a computing device 32, and/or other sources of data related to care recipient 12.

Electronic storage 16 may store an activity queue (described below) of activity tasks generated for care recipient 12. The activity queue may include prioritized activity tasks. Activity task items in the activity queue can be actively assigned to specific caregivers or passively requested from electronic storage 16 by the caregivers.

Electronic storage 16 stores caregiver profile information for caregivers. The caregiver profile information includes schedule information, resource information, relationship information, historical information, location information, and/or other information for individual caregivers. The caregiver profile information includes caregiver profile information for individual caregivers that is stored in corresponding individual caregiver profiles. The information may include dates and times the caregiver is available and/or unavailable. The information may include resources that the caregiver has available (e.g., a car, a lawnmower, financial resources, specific skills and/or abilities, etc.) to perform a task. In some embodiments, the information includes skills that the caregiver can provide. For example, if the caregiver is a nurse or doctor that individual caregiver may be able to provide care recipient 12 different services than a caregiver that is an accountant. Both caregivers may be able to provide necessary services to care recipient 12.

Relationship information may be stored in electronic storage 16. In some embodiments, relationship information may determine whether an activity task is appropriate for the caregivers' relationship and/or circle. For example, a neighbor may be available to make an occasional dinner and/or check the mailbox. But the neighbor relationship may not be comfortable changing bed pans. A closer relationship (e.g. a son or a daughter) may be willing to provide any activity task, including changing bed pans. This information may be stored in electronic storage 16 to enable proper assignment of activity tasks.

Electronic storage 16 may store historical information. Historical information provides a strong indication of both willingness and capability to perform a specific task. For example, if a caregiver routinely buys groceries for care recipient 12 on Saturday, the caregiver may reasonably be requested to do grocery shopping the following Saturday. Historical information may enable additional activity task requests. For example, the caregiver may be requested to fill a prescription in the neighboring pharmacy while grocery shopping on Saturday.

Location information may be stored in electronic storage 16. Some activity tasks may be conducive or prohibitive based on the individual caregiver's residential information. For example, an individual caregiver that resides out of state may not routinely do grocery shopping, but may manage finances for care recipient 12. In some embodiments, a caregiver's location at a particular time assigns particular activity tasks. For example, assigning an activity task to buy a particular grocery while an individual caregiver shops for groceries. A caregiver may work near a hospital or doctor's office that care recipient 12 frequently visits.

Electronic storage 16 comprises electronic storage media that electronically stores information. The electronic storage media of electronic storage 16 may comprise one or both of system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 16 may comprise one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 16 may store software algorithms, information determined by processor 20, information received via user device 12, and/or other information that enables system 10 to function properly. Electronic storage 16 may be (in whole or in part) a separate component within system 10, or electronic storage 16 may be provided (in whole or in part) integrally with one or more other components of system 10.

External resources 36 may include sources of activity information and/or other information (e.g. 3^{rd} party information sources, websites, medical devices, fitness devices, pedometers, activity trackers, personal devices that may be carried on care recipient 12 and/or worn by care recipient 12, household appliances, consumer electronics, televisions, telephones, etc.), external entities participating with system 10, and/or other resources. In some embodiments, some or all of the functionality attributed herein to external resources 36 may be provided by resources included in system 10. For example, an external resource 36 may include a watch configured to measure and/or monitor one or more physiological characteristics of care recipient 12. In some embodiments, external resource 36 may include one or more sensors 18. One or more components of system 10 may access a database(s), sensor(s) 18, appliance(s), watch(es), and/or other external resources 36.

Sensor 18 is configured to generate output signals conveying information related to physiological, environmental, and/or care recipient-specific (medical) parameters, and/or other information or parameters related to care recipient 12. System 10 may use any of the generated output signals to monitor care recipient 12. In some embodiments, the conveyed information may be related to parameters associated with the state and/or condition of care recipient 12, motion of care recipient 12, wakefulness and/or sleep state of care recipient 12, the breathing of care recipient 12, the heart rate of care recipient 12, the respiratory rate of care recipient 12, vital signs of care recipient 12, including one or more temperatures, oxygen saturation of arterial blood (SpO₂), whether peripheral or central, and/or other parameters. In some embodiments, one or more sensors 18 may generate output signals conveying information related to a position and/or location of care recipient 12, e.g. through stereoscopy, global positioning system (GPS) information, and/or other information. The location may be a three-dimensional location of care recipient 12, a two-dimensional location of care recipient 12, a location of a specific body part of care recipient 12 (e.g., eyes, arms, legs, a face, a head, a forehead, and/or other anatomical parts of care recipient 12), the posture of care recipient 12, the orientation of care recipient 12 or one or more anatomical parts of care recipient 12, and/or other locations. In some embodiments, one or more sensors 18 may generate output signals conveying information related to care recipient's 12 speech and/or interaction with other users. For example, a particular external resource 36 may monitor, track, and/or quantify interactions of care recipient 12. For example, sensors 18 may include one or more of a light sensor, an optical sensor, a temperature sensor, a pressure sensor, a weight sensor, an electromagnetic (EM) sensor, an infra-red (IR) sensor, a microphone, a transducer, a still-image camera, a video camera, and/or other sensors and combinations thereof.

The illustration of sensor 18 including one member in FIG. 1 is not intended to be limiting. System 10 may include one or more sensors. The illustration of a particular symbol or icon for sensor 18 in FIG. 1 is exemplary and not intended to be limiting in any way. Resulting signals or information from one or more sensors 18 may be transmitted to processor 20, user interface 30, external resources 36, electronic storage 16, and/or other components of system 10. This transmission can be wired and/or wireless.

One or more sensors 18 may be configured to generate output signals in an ongoing manner, e.g. throughout the day, week, month, and/or year(s). This may include generating signals intermittently, periodically (e.g. at a sampling rate), continuously, continually, at varying intervals, and/or in other ways that are ongoing during at least a portion of period of a day, week, month, or other duration. It is noted that multiple individual sensors may operate using different sampling rates, as appropriate for the particular output signals and/or (frequencies related to particular) parameters derived therefrom. Different parameters of the signal may be related to different vectors. For example, a particular parameter of care recipient 12 may be determined in an ongoing manner from a vector of output signals that may be represented as a vector of that particular parameter.

One or more sensors 18 may be configured to generate output signals related to gas parameters (e.g. an apnea device for sleeping) of care recipient 12 undergoing respiratory therapy, heart information, blood information, physical activity, and/or other information. For example sensors 18 may include heart monitors, glucose monitors, pedometers, and/or other devices relating to the health of care recipient 12. Sensor 18 may comprise one or more sensors that generate information directly and/or indirectly from care recipient 12. For example, sensor 18 may monitor blood glucose levels with a contact lens that measures glucose levels in the tear ducts of care recipient 12. Sensor 18 may comprise one or more sensors configured to generate an output indirectly based on an operating parameter of a respiratory therapy flow device (e.g., motor current, voltage, rotational velocity, and/or other operating parameters), and/or other sensors.

In some embodiments, sensor 18 comprises one or more heart rate sensors configured to generate output signals conveying information related to heart rate of care recipient 12. Heart rate sensors may detect interruption or absence in heart rate. Sensor 18 may be used to determine a rate of fluid flow for the heart and/or other fluid systems in the body (e.g. airway). Sensors suitable for use as sensor 18 may include, for example, mechanical flow rate sensors, pressure sensors, pressure based flow rate sensors, optical flow rate sensors, thermal mass flow rate sensors, magnetic flow rate sensors, and/or other flow rate sensors.

In some embodiments, sensor 18 comprises one or more pressure sensors configured to generate output signals conveying information related to the pressure of a pressurized flow of breathable gas delivered to care recipient 12 as part of respiratory therapy. Pressure sensors suitable for use as sensor 18 may include, for example, mechanical sensors, capacitive sensors, electromagnetic sensors, piezoelectric sensors, optical sensors, dual lumen sensors, and/or other pressure sensors. In some embodiments, sensor 18 may comprise one or more oxygen sensors configured to generate output signals related to the concentration of oxygen in the pressurized flow of breathable gas delivered to and/or exhaled by care recipient 12.

Although sensor 18 is illustrated in FIG. 1 at a single location in system 10, this is not intended to be limiting. Sensor 18 may comprise sensors disposed in a plurality of locations. Sensor 18 may be placed within, on, and/or external to care recipient 12. Sensor 18 may be placed on a medical cabinet and/or pill dispenser to ensure that the pills are dispensed at the proper times. Moreover, sensor 18 may be placed on care recipient 12 to detect brain wave activity and/or heart activity.

Computing device 32 may be configured to provide a user interface 30, processing capabilities, databases, and/or electronic storage to system 10. As such, computing device may include processor 20, electronic storage 16, external resources 36, user interface 30, and/or other components of system 10. Computing device 32 may be a laptop, personal computer, cellular phone, tablet, and/or have other configurations. Computing device 32 may be connected to network 34. The connection to network 34 may be wireless or wired. Computing device may be connected (wireless and/or wired) to sensor 18 and/or other components of system 10.

User interface 30 may be configured to provide an interface between computing device 32 and the user through which the user may provide information to and receive information from system 10 (e.g., such that the care recipient and/or caregivers may enter, select, email text, and/or otherwise communicate activity tasks). This enables data, cues, results, and/or instructions and any other communicable items, collectively referred to as “information,” to be communicated between the user and system 10. Examples of interface devices suitable for inclusion in user interface 30 include a touch screen, a keypad, touch sensitive and/or physical buttons, switches, a keyboard, knobs, levers, a display, speakers, a microphone, an indicator light, an audible alarm, a printer, and/or other interface devices. In some embodiments, user interface 30 includes a plurality of separate interfaces. In some embodiments, user interface 30 includes at least one interface that is provided integrally with computing device 32.

It is to be understood that other communication techniques, either hard-wired or wireless, are also contemplated by the present disclosure as user interface 30. For example, the present disclosure contemplates that user interface 30 may be integrated with a removable storage interface provided by computing device 32. In this example, information may be loaded into computing device 32 from removable storage (e.g., a smart card, a flash drive, a removable disk) that enables the user to customize the implementation of computing device 32. Other exemplary input devices and techniques adapted for use with computing device 32 as user interface 30 include, but are not limited to, an RS-232 port, RF link, an IR link, modem (telephone, cable or other). In short, any technique for communicating information with computing device 32 and/or other components of system 10 is contemplated by the present disclosure as user interface 30.

Physical computer processor 20 (interchangeably referred to herein as processor 20) is configured to provide information processing capabilities in system 10. One or more processors 20 are in operative communication with electronic storage 16, computing platform 32, user interface 30, sensors 18, external resources 36, and/or other components of system 10. Processor(s) 20 may comprise one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some embodiments, processor 20 may comprise a plurality of processing units. These processing units may be physically located within the same device (e.g., computing platform 32, in a system server (not shown), or processor 20 may represent processing functionality of a plurality of devices operating in coordination. In some embodiments, processor 20 is a server or a system of servers configured with one or more processor 20 components 22, 24, 26, and/or 28.

Processor 20 is configured to execute one or more computer program components. The one or more computer program components may include one or more of an information component 22, a task component 24, a metric component 26, a communication component 28, and/or other components. Processor 20 may be configured to execute components 22, 24, 26, and/or 28 by software; hardware; firmware; some combination of software, hardware, and/or firmware; and/or other mechanisms for configuring processing capabilities on processor 20.

It should be appreciated that although components 22, 24, 26, and 28 are illustrated in FIG. 1 as being co-located within a single processing unit, in embodiments in which processor 20 includes multiple processing units, one or more of components 22, 24, 26, and/or 28 may be located remotely from the other components. The description of the functionality provided by the different components 22, 24, 26, and/or 28 described below is for illustrative purposes, and is not intended to be limiting, as any of components 22, 24, 26, and/or 28 may provide more or less functionality than is described. For example, one or more of components 22, 24, 26, and/or 28 may be eliminated, and some or all of its functionality may be provided by other components 22, 24, 26, and/or 28. As another example, processor 20 may be configured to execute one or more additional components that may perform some or all of the functionality attributed below to one of components 22, 24, 26, and/or 28.

Information component 22 is configured to facilitate storage of electronic information in electronic storage 16 and/or in other locations. Information component 22 is configured to facilitate storage of care recipient profile information (e.g. entered and/or selected via user interface 30, generated by sensors 18, and/or obtained in other ways) for care recipient 12 in a care recipient profile stored in electronic storage 16, caregiver information in caregiver profiles for the individual caregivers, and/or other information. Information component 22 is configured to facilitate storage of activity tasks (described below), the activity task queue (described below), and/or other information in electronic storage 16 and/or in other locations. Information component 22 may be configured to update and/or obtain information stored in electronic storage 16, and/or in other locations. For example, information component 22 may access one or more databases included in external resources 36 to obtain information (e.g., medical information, resource information, schedule information, etc.) about care recipient 12, individual caregivers, and/or other users.

Information component 22 is configured to facilitate storage and/or retrieval of dynamic and static information associated with care recipient 12, caregivers, and/or other users. For example, location information in the caregiver profiles may include static and dynamic location information. Static location information may indicate a location of a caregiver's residence in relation to a residence of care recipient 12. Information component 22 may be configured to obtain this information prior to and/or while assigning an activity task, and/or at other times. Dynamic location information may indicate a caregiver's current location relative to the residence of care recipient 12. Information component 22 may facilitate the storage and/or retrieval of dynamic location information in electronic storage 22.

Information component 22 is configured to facilitate storage and/or retrieval of caregiver schedule information, resource information (e.g., whether or not a caregiver owns a car/lawnmower/etc., whether or not a caregiver has medical equipment, financial resources, specific skills and/or capabilities, etc.), relationship information (e.g., how is the caregiver related to care recipient 12), historical information (how has the caregiver previously helped care recipient 12), location information (as described above, e.g., how far away is the caregiver from care recipient 12), and/or other information for individual caregivers. Information component 22 may obtain caregiver profile information that includes historical information indicating previous care provided by a caregiver to care recipient 12, schedule information related to a daily, weekly, monthly schedule of care recipient 12 and/or one or more caregivers (e.g., electronic calendar information), and/or other information. In some embodiments, information component 22 obtains information from one or more health sensor 18 output signals that convey information related to a physical condition of care recipient 12 and/or other sensors. Information component 22 may determine information about care recipient 12 based on the output signals, for example, store information conveyed by the output signals, and/or retrieve information conveyed by the output signals previously stored in electronic storage 16.

In some embodiments, information component 22 is configured to determine relationship closeness (to care recipient 12) levels for caregivers. Information component 22 may be configured such that relationship closeness of a given caregiver to care recipient 12 is indicated by a circle (e g, family, close friends, friends, neighbors, associates, and/or others) an individual caregiver belongs to, a relationship closeness level, and/or other indications. Circles may be comprised of one or more caregivers who share a similar level of relationship closeness with care recipient 12. In some embodiments, information component 22 is configured such that information related to one or more circles that a caregiver belongs to is stored electronically in the caregiver profiles (as described above). In some embodiments, circles may be defined and/or obtained by information component 22 based on information in the care recipient profile for care recipient 12, information in the caregiver profiles, information related to activity tasks (described below) historically performed by an individual caregiver, and/or based on other information.

In some embodiments, information component 22 is configured such that relationship closeness between care recipient 12 and a given caregiver may be indicated by one or more relationship closeness levels. In some embodiments, relationship closeness levels may include a first level relationship, a second level relationship, and so on. For example, a first level relationship may correspond to a family member, a second level relationship metric may correspond to a friend, and a third level relationship may correspond to a medical professional, and/or other licensed caregivers. In some embodiments, levels may be defined and/or obtained by information component 22 based on information in the care recipient profile for care recipient 12, information in the caregiver profiles, information related to activity tasks (described below) historically performed by an individual caregiver, and/or based on other information. Information component 22 is configured such that relationship closeness level information is electronically stored in the care recipient profile for care recipient 12, the caregiver profiles, and/or in other locations.

Task component 24 is configured to obtain and/or otherwise generate activity tasks about care recipient 12. In some embodiments, task component 24 is configured to obtain activity tasks about care recipient 12 from care recipient 12, one or more caregivers, and/or other users via a computing system associated with care recipient 12, the one or more caregivers, and/or the other users. In some embodiments, task component 24 is configured such that one or more of the activity task requests are generated manually by care recipient 12, a caregiver, and/or other users. Care recipient 12, a caregiver, and/or other users may enter and/or select information via a user interface of a computing device electronically linked with system 10 that the user is associated with; email, text, and/or otherwise communicate an activity task request that is received by task component 24; and/or manually generate a task in other ways. In some embodiments, task component 24 is configured such that an activity task may be manually generated based on caregiver observation of care recipient 12, information provided by a caregiver before, during, and/or after completing an activity task, and/or other information. For example, care recipient 12 may need help performing specific activities (e.g., taking a shower, mowing the lawn, changing bandages, paying the bills, etc.) and may enter those activities as activity tasks into system 10 via a computing device associated with care recipient 12 that communicates with system 10. As another example, one or more caregivers may know the needs of care recipient 12 and enter corresponding activity tasks into system 10.

In some embodiments, task component 24 is configured to generate activity tasks for care recipient 12 based on information in the care recipient profile for care recipient 12, and/or other information. Activity tasks are performed to care for care recipient 12 and have associated activity information. Activity information indicates an estimated time commitment necessary to complete a given activity task, an activity task type, required caregiver resources, a need (e.g. priority) level, and/or other information related to a given activity task. Task component 24 is configured to generate a queue of activity tasks for care recipient 12 based on the generated activity tasks, the activity information for the generated activity tasks, information in the care recipient profile for care recipient 12, and/or other information. Task component 24 may be configured such that activity tasks are ranked and/or ordered in the activity task queue according to the needs of care recipient 12 (e.g., when care recipient 12 requires that the activity task be complete), and/or other information. Task component 24 is configured to rank and/or order the activity tasks in the activity task queue based on the activity information, information in the care recipient profile for care recipient 12, and/or other information.

By way of a non-limiting example, the caregiver may be provided with an electronic questionnaire via a user interface of a computing device associated with the caregiver subsequent to completing a previous activity task. In some embodiments, the caregiver's responses to the questionnaire may cause task component 24 to generate additional activity tasks. Continuing with this example, a first activity task that requests (e.g., communicated to a specific caregiver as described below) a caregiver to go grocery shopping for care recipient 12 may also request that the caregiver provide the quantity of milk then available to care recipient 12 to system 10 via a user interface of a computing system associated with the caregiver. Task component 24 may be configured to generate additional activity tasks based on the caregiver's response, the profile information for care recipient 12 (e.g., dietary restrictions described in the care recipient profile), and/or other information. In this example, task component 24 may be configured to generate additional activity tasks that request more or less milk in subsequent grocery shopping activity tasks based on the information provided by the caregiver, the care recipient profile information for care recipient 12, and/or other information.

By way of a second non-limiting example, task component 24 may be configured such that activity tasks may be manually generated from observation of care recipient 12. In some embodiments, a caregiver may notice that care recipient 12 appears lethargic and/or depressed. Task component 24 is configured such that, based on such an observation, the caregiver may manually generate (e.g., via a user interface of a computing device associated with the care giver) an activity task that requests other caregivers to show love and/or support for care recipient 12.

Metric component 26 is configured to determine likelihood metric values for the one or more caregivers and the activity tasks in the activity task queue. Likelihood metric values for a given caregiver and a given activity task indicate capacity and/or likelihood of the given caregiver to perform the given activity task. The likelihood metric values are determined based on activity information for the individual activity tasks, the position (e.g., relative priority ranking) of an activity task in the activity task queue, the profile information in the care recipient profile for care recipient 12, the profile information in the individual caregiver profiles, and/or other information (e.g., this may include urgency information, historical information, profile information (e.g. of care recipient 12 and/or the caregiver), resource information, location information, and/or other information). Likelihood metric values include individual metric values for a given caregiver and individual tasks in the task queue. Likelihood metric values may be different for individual caregivers even though the tasks in the activity task queue for care recipient 12 are the same.

By way of a non-limiting example, a first caregiver may be assigned a first likelihood metric value for a first task that is different from a second caregiver likelihood metric value assigned to a second caregiver for the first task. In this example, metric component 26 may determine a likelihood metric value for the first caregiver and the first activity task that indicates that a first caregiver is best suited and/or most likely to complete the first activity task. In some embodiments, metric component 26 may be configured such that a second set of likelihood metric values for a second caregiver is different from a first set of likelihood metric values for a first caregiver, even though the tasks in the activity task queue for care recipient 12 are the same. Metric component 26 is configured such that these differences may arise based on (e.g., as described above) historical care provision information in the caregiver profiles, location information associated with care recipient 12 and/or the caregivers, schedule information for care recipient 12 and/or the caregivers, caregiver resource information, care recipient 12/caregiver relationship information (e.g., circles, levels), and/or other information.

In some embodiments, metric component 26 may be configured such that determining likelihood metric values for the one or more caregivers and the activity tasks in the activity task queue includes determining intrusive metric values and/or required caregiver relationship levels for individual activity tasks. Intrusive metric values indicate a level of intrusiveness required for a given activity task. Required relationship levels for individual activity tasks may indicate a level of relationship closeness between care recipient 12 and a caregiver that completes an activity task. Metric component 26 is configured such that intrusive metric values and/or required caregiver relationship levels are determined based on activity information for the individual activity tasks, the position (e.g., relative priority ranking) of an activity task in the activity task queue, the profile information in the care recipient profile for care recipient 12, the profile information in the individual caregiver profiles, and/or other information. Intrusive metric values and/or required caregiver relationship levels may be determined because some activity tasks (e.g., such as driving care recipient 12 to an appointment) may be less intrusive for care recipient 12 and some activity tasks (e.g., changing a catheter, changing clothes, etc.) may be very intrusive for care recipient 12. It may follow that care recipient 12 prefers that more intrusive tasks be performed by close family members and/or very close friends, and care recipient 12 has no preference as to who (e g, family members, friends, neighbors) performs less intrusive activity tasks (e.g., such as being driven to appointments, etc.).

As described above, relationship closeness levels for caregivers may be indicated by a circle (e.g., family, close friends, friends, neighbors, associates, and/or others) an individual caregiver belongs to, a relationship closeness level, and/or other information. In some embodiments, information related to one or more circles that the caregiver belongs to and/or a relationship closeness level with care recipient 12 is stored electronically in the caregiver profiles (as described above). In some embodiments, metric component 26 determines likelihood metric values for activity tasks and individual caregivers based at least in part on one or more circles that the caregiver is associated with and/or a relationship closeness level between care recipient 12 and a given caregiver. By way of a non-limiting example, metric component 26 may determine higher likelihood metric values for a wound dressing activity task for caregivers associated with a family and/or medical professional circle, which may be more willing to dress an infected wound. Whereas metric component 26 may determine higher likelihood metric values for a making/delivering dinner activity task for neighbors who are close by and who may be willing to make and deliver a dinner.

Process component 27 is configured to match activity tasks to caregivers and determine which caregivers should be prompted to perform which activity tasks. The matches may be determined based on the likelihood metric values that indicate whether individual caregivers have the capacity and/or likelihood to complete individual activity tasks, information determined by task component 24, information obtained and/or determined by information component 22, and/or other information. In some embodiments, process component 27 is configured to compare and/or rank likelihood metric values for individual caregivers and individual activity tasks to likelihood metric values for other caregivers and the same individual activity tasks (e.g., a value of a metric for a first caregiver and a first activity compared to a value metric for a second caregiver and the first activity). Process component 27 may be configured to determine which caregiver to prompt to complete an individual activity task based on this comparison.

In some embodiments, process component 27 is configured to order caregivers from likeliest to complete an activity task to least likely to complete an activity task and prompt the caregivers in order so that if a first caregiver is unable and/or unwilling to complete a first activity task, process component 27 facilitates prompting a second most likely caregiver to complete the task (and so on). For example, if a first caregiver with a strong likelihood metric value for a specified activity communicates that the first caregiver is unable to complete the activity task, then process component 27 may match the activity task to a second caregiver (e.g., the second caregiver with the second strongest likelihood metric values). The process may repeat until a caregiver with a suitable likelihood metric value for the activity task is able to complete the activity task.

In some embodiments, process component 27 is configured such that determining which caregivers should perform which activity tasks is based on likelihood metric value thresholds (e.g., the likelihood metric value breaches some threshold level that indicates likeliness of the caregiver to complete the activity), and/or other information. Such threshold levels may be determined at manufacture, entered and/or selected via a user interface by care recipient 12, caregivers, and/or other users, determined based on the information obtained by information component 22, and/or determined in other ways. In instances where likelihood metric values for one or more caregivers breach a threshold level, process component 27 may determine who to prompt to complete the associated activity task based on the individual likelihood metric values for the different caregivers, determine who to prompt based on the information obtained by information component 22, and/or determine who to prompt in other ways.

In some embodiments, process component 27 may adjust and/or alter a likelihood metric value based on previous and/or recent participation of a caregiver. For example, if a first caregiver completes an individual activity task this week, the first caregiver may have a higher likelihood of completing the individual activity task in subsequent weeks. The first caregiver may have a decreased likelihood metric based on recent participation. For example, completing the first activity task today may lessen the first caregiver's likelihood metric values for other activity tasks. The likelihood metric values may rise as a function of time to indicate an indicated likelihood to participate in other activity tasks (e.g., completion of a task today may indicate that a week later, or some other time period, I may be more likely to contribute to another activity task).

In some embodiments, process component 27 is configured such that individual activity task queues are created for individual caregivers by prioritizing activity tasks for the caregivers based on the activity information for the individual activity tasks, the profile information in the individual caregiver profiles, the likelihood metric values, activity tasks previously performed by a caregiver, and/or other information. Such caregiver activity task queues may be generated so that an individual caregiver may plan and/or prepare in advance for performing multiple activity tasks for care recipient 12 on a single visit with care recipient 12, and/or for other reasons. This may also allow for a caregiver to decline one or more activity tasks well in advance of a needed completion date so that process component 27 match the declined activity task to a new caregiver and prompt that caregiver to complete the activity task.

It should be noted that the above description of determining whether a caregiver is likely to perform an activity task based on the relationship between the caregiver and care recipient 12 (e.g., circle, level), the intrusiveness of an activity task, and/or the other information described and then assigning the activity task to a caregiver based on the likelihood metric values is not intended to be limiting. There are a number of different possibilities for determining which caregiver is best suited/available/likely to perform a task and then assigning the task to the appropriate caregiver. The approach described above is just one example.

Communication component 28 is configured to communicate the individual activity tasks to the individual caregivers. Communication component 28 is configured to communicate the individual activity tasks based on the determinations by process component 27 (e.g., responsive to the likelihood metric values indicating that individual caregivers have the capacity and/or likelihood to complete the individual activity tasks). For example, responsive to a first likelihood metric value indicating that a first caregiver has the capacity and/or likelihood to complete the first activity task, the first activity task is communicated to the first caregiver. Similarly, responsive to a second likelihood metric value indicating that a second caregiver has the capacity and/or likelihood to complete a second activity task, the second activity task is communicated to the second caregiver. Communication component 28 may be configured to communicate an activity task to a caregiver for completion via a text message, an email, a phone call, an electronic app and/or web page (e.g., a caregiver may log into system 10 via an app/webpage to view activity task that the caregiver has been requested to complete), an electronic app notification, a meeting request, and/or with other communications.

In some embodiments, communication component 28 may actively request, and/or passively request, a caregiver to complete a task. For example, communication component 28 may actively (e.g., through an email/voicemail/text/etc.) specify an activity task on a first caregiver's electronic calendar. Communication component 28 may passively request participation from one or more caregivers and the activity tasks in the queue. For example, communication component 28 may present an activity queue to all caregivers associated with a care recipient profile (e.g., via an electron app interface, a website, etc.). Caregivers may select activities that fit in within their preferred schedules, abilities, and/or other personal constraints. Communication component 28 may be configured to remove an activity task from an activity task queue for care recipient 12 when a caregiver volunteers to complete the task. In some embodiments, communication component 28 is configured such that other caregivers may see who has volunteered for an activity task. In some embodiments, communication component 28 communications facilitate caregiver competition to perform the most activity tasks (e.g., a list of who has completed the most activity tasks may be posted to a website accessed by the caregivers).

Communication component 28 may enable a caregiver to recommend someone else to complete an activity task. For example, a caregiver may not be able to perform a historical task that has routinely been assigned to them, but may know another caregiver that has offered to substitute that activity task in their absence. As another example, a caregiver may know someone within care recipient 12's circle that is particularly skilled or excited to perform a particular activity task. Care recipient 12's grandson may have just turned 16 and received a new driver's license. Although the grandson has never been a caregiver previously, communication component 28 may enable a caregiver to request he drive to the store. Communication component may enable caregivers to add and/or suggest activity tasks to others.

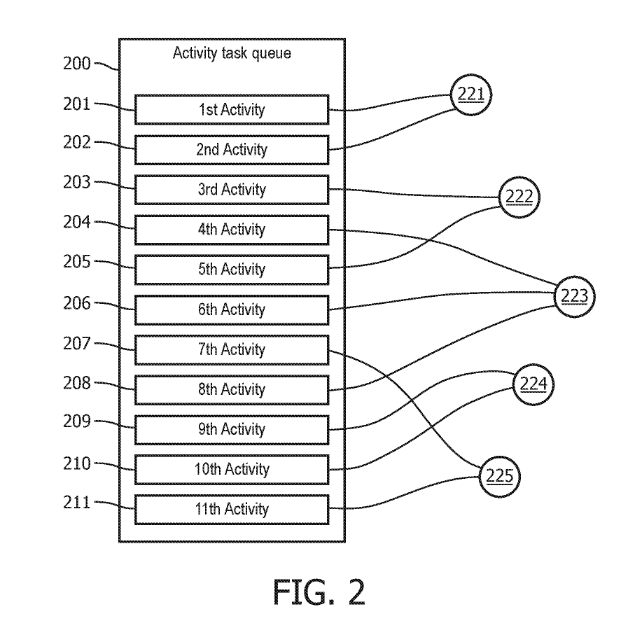

FIG. 2 illustrates exemplary activity task assignments made to individual caregivers. Activity tasks 201 through 211 are listed within an activity task queue 200. Activity task queue 200 may prioritize tasks 201 through 211 based on the care recipient's profile and/or other information. In some embodiments, activity tasks are prioritized for care recipient 12 and for the individual caregivers. Five caregivers (e.g., caregivers 221-225) are identified and assigned activity tasks. The activity tasks may be assigned actively by communication component 28, passively selected by the caregivers, and/or assigned in other ways. FIG. 2 illustrates caregiver 221 being assigned activity tasks 201 and 202. Caregiver 222 is assigned activity tasks 203 and 205. Caregiver 223 is assigned activity tasks 204, 206, and 208. Caregiver 224 may have passively volunteered for activity tasks 209 and 210, but caregiver 225 may have been actively assigned activity tasks 207 and 211.

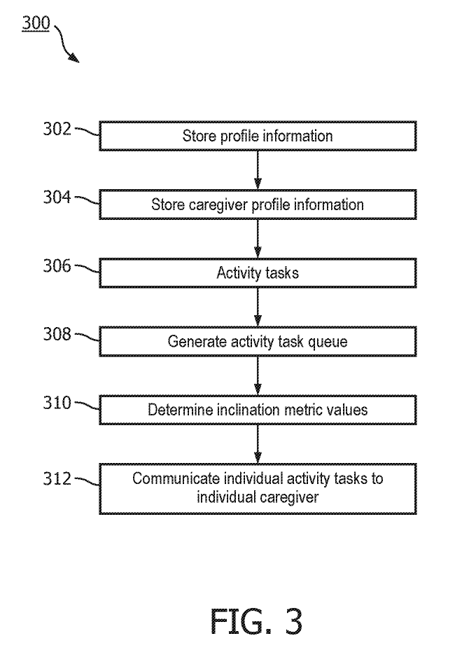

FIG. 3 illustrates a method 300 to provide a care recipient a care-based activity recommendation engine. The engine comprises electronic storage and one or more physical computer processors. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At an operation 302, care recipient profile information is stored in electronic storage. The care recipient profile information for care recipient 12 is stored in a care recipient profile associated with care recipient 12 and includes information related to care needs of care recipient 12. In some embodiments, operation 302 is performed by an information component and/or electronic storage the same as or similar to information component 22 and/or electronic storage 16 (shown in FIG. 1 and described herein).

At an operation 304, caregiver profile information for two or more caregivers is stored in electronic storage. The caregiver profile information may include one or more of schedule information, resource information, relationship information, or location information for individual caregivers. The caregiver profile information includes first caregiver profile information stored in a first caregiver profile for a first caregiver and second caregiver profile information stored in a second caregiver profile for a second caregiver. In some embodiments, operation 304 is performed by information component and/or electronic storage the same as or similar to information component 22 and/or electronic storage 16 (shown in FIG. 1 and described herein).

At an operation 306, activity tasks for care recipient 12 based on the care recipient profile are generated. The activity tasks are performed to care for care recipient 12. The activity tasks may have associated activity information that indicates one or more of an estimated time commitment, an activity task type, or required caregiver resources for a given activity task. The activity tasks may include a first activity task having first activity information and a second activity task having second activity information. In some embodiments, operation 306 is performed by a task component circuit the same as or similar to task component 24 (shown in FIG. 1 and described herein).

At an operation 308, a queue of activity tasks for care recipient 12 based on the activity information and the care recipient profile are generated. In some embodiments, operation 308 is performed by a task component the same as or similar to task component 24 (shown in FIG. 1 and described herein).

At an operation 310, likelihood metric values for the one or more caregivers and the activity tasks in the queue are determined. The likelihood metric value for a given caregiver and a given activity task indicate capacity and/or likelihood of the given caregiver to perform the given activity task. The likelihood metric values may be determined based on activity information for the individual activity tasks and the profile information in the individual caregiver profiles. The likelihood metric values may include a first likelihood metric value for the first caregiver and the first activity task, and a second likelihood metric value for the second caregiver and the first activity task. In some embodiments, operation 310 is performed by a metric component the same as similar to metric component 26 (shown in FIG. 1 and described herein).

At an operation 312, the individual activity task is communicated to the individual caregiver, responsive to the likelihood metric values indicating that the individual caregiver has the capacity and/or likelihood to complete the individual activity task. The individual activity task is communicated such that, responsive to the first likelihood metric values indicating that the first caregiver has the capacity and/or likelihood to complete the first activity task, the first activity task is communicated to first caregiver, and, responsive to the second activity information, the second caregiver profile information, and the second likelihood metric values indicating that the second caregiver has the capacity and/or likelihood to complete the second activity task, the second activity task is communicated to the second caregiver. In some embodiments, operation 312 is performed by a communication component the same as or similar to communication component 28 (shown in FIG. 1 and described herein).

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A system configured to provide a care recipient care-based activity recommendation engine, the system comprising:
electronic storage configured to:
store care recipient profile information for a care recipient in a care recipient profile associated with the care recipient, the care recipient profile information including information related to care needs of the care recipient; and
store caregiver profile information for two or more caregivers, the caregiver profile information including one or more of schedule information, resource information, relationship information, or location information for individual caregivers, the caregiver profile information including first caregiver profile information stored in a first caregiver profile for a first caregiver and second caregiver profile information stored in a second caregiver profile for a second caregiver; and
one or more physical computer processors in operative communication with the electronic storage and configured by computer readable instructions to:
obtain activity tasks about the care recipient, the activity tasks determined based on the care recipient profile, the activity tasks performed to care for the care recipient, the activity tasks having associated activity information, the activity information indicating one or more of an estimated time commitment, an activity task type, or required caregiver resources for a given activity task, the activity tasks including a first activity task having first activity information and a second activity task having second activity information;
generate a queue of activity tasks for the care recipient based on the activity information and the care recipient profile;
determine likelihood metric values for the one or more caregivers and the activity tasks in the queue, the likelihood metric value for a given caregiver and a given activity task indicating capacity and/or likelihood of the given caregiver to perform the given activity task, the likelihood metric values being determined based on activity information for the individual activity tasks and profile information in the individual caregiver profiles, the likelihood metric values including a first likelihood metric value for the first caregiver and the first activity task, and a second likelihood metric value for the second caregiver and the second activity task; and
responsive to the likelihood metric values indicating that individual caregivers have the capacity and/or likelihood to complete individual activity tasks, communicate the individual activity tasks to the individual caregivers such that, responsive to the first likelihood metric value indicating that the first caregiver has the capacity and/or likelihood to complete the first activity task, the first activity task is communicated to first caregiver, and, responsive to the second likelihood metric value indicating that the second caregiver has the capacity and/or likelihood to complete the second activity task, the second activity task is communicated to the second caregiver.

2. The system of claim 1, wherein the one or more physical computer processors are configured such that the location information in the caregiver profiles includes static and dynamic location information, the static location information indicating a location of a caregiver's residence in relation to a residence of the care recipient, the dynamic location information indicating a caregiver's current location relative to the residence of the care recipient.

3. The system of claim 1, wherein the one or more physical computer processors are configured such that the caregiver profile information includes historical information indicating previous care provided by a caregiver to the care recipient.

4. The system of claim 1, wherein the one or more physical computer processors are further configured to obtain one or more health sensor output signals that convey information related to a physical condition of the care recipient, and generate the activity tasks and the activity task queue based on the output signals.

5. The system of claim 1, wherein the one or more physical computer processors are configured such that the activity task type indicates whether an activity task should be performed by one or more of a family member, a friend, or a medical professional.

6. The system of claim 1, wherein the one or more physical computer processors are configured such that one or more of the activity tasks requests are generated manually by a caregiver based on caregiver monitoring and/or observation of the care recipient.

7. A method to provide a care recipient care-based activity recommendation engine, the engine comprising electronic storage and one or more physical computer processors, the method comprising:
storing, in electronic storage, care recipient profile information for the care recipient in a care recipient profile associated with the care recipient, the care recipient profile information including information related to care needs of the care recipient;
storing, in electronic storage, caregiver profile information for two or more caregivers, the caregiver profile information including one or more of schedule information, resource information, relationship information, or location information for individual caregivers, the caregiver profile information including first caregiver profile information stored in a first caregiver profile for a first caregiver and second caregiver profile information stored in a second caregiver profile for a second caregiver;
obtaining, with the one or more physical computer processors, activity tasks about the care recipient, the activity tasks determined based on the care recipient profile, the activity tasks performed to care for the care recipient, the activity tasks having associated activity information, the activity information indicating one or more of an estimated time commitment, an activity task type, or required caregiver resources for a given activity task, the activity tasks including a first activity task having first activity information and a second activity task having second activity information;
generating, with the one or more physical computer processors, a queue of activity tasks for the care recipient based on the activity information and the care recipient profile;
determining, with the one or more physical computer processors, likelihood metric values for the individual caregivers and the activity tasks in the queue, the likelihood metric value for a given caregiver and a given activity task indicating capacity and/or likelihood of the given caregiver to perform the given activity task, the likelihood metric values being determined based on activity information for the individual activity tasks and the profile information in the individual caregiver profiles, the likelihood metric values including a first likelihood metric value for the first caregiver and the first action task, and a second likelihood metric value for the second caregiver and the first action task; and
responsive to the likelihood metric values indicating that the individual caregiver has the capacity and/or likelihood to complete the individual activity task, communicating the individual activity task to the individual caregiver such that, responsive to the first activity information, the first caregiver profile information, and the first likelihood metric values indicating that the first caregiver has the capacity and/or likelihood to complete the first activity task, the first activity task is communicated to first caregiver, and, responsive to the second activity information, the second caregiver profile information, and the second likelihood metric values indicating that the second caregiver has the capacity and/or likelihood to complete the second activity task, the second activity task is communicated to the second caregiver.

8. The method of claim 7, wherein the one or more physical computer processors are configured such that the location information in the caregiver profiles includes static and dynamic location information, the static location information indicating a location of a caregiver's residence in relation to a residence of the care recipient, the dynamic location information indicating a caregiver's current location relative to the residence of the care recipient.

9. The method of claim 7, wherein the one or more physical computer processors are configured such that the caregiver profile information includes historical information indicating previous care provided by a caregiver to the care recipient.

10. The method of claim 7, wherein the one or more physical computer processors are further configured to obtain one or more health sensor output signals that convey information related to a physical condition of the care recipient, and generate the activity tasks and the activity task queue based on the output signals.

11. The method of claim 7, wherein the one or more physical computer processors are configured such that the activity task type indicates whether an activity task should be performed by one or more of a family member, a friend, or a medical professional.

12. The method of claim 7, wherein the one or more physical computer processors are configured such that one or more of the activity tasks requests are generated manually by a caregiver based on caregiver monitoring and/or observation of the care recipient.

13. A system configured to provide a care recipient care-based activity recommendation engine, the system comprising:
means for storing care recipient profile information for the care recipient in a care recipient profile associated with the care recipient, the care recipient profile information including information related to care needs of the care recipient;
means for storing caregiver profile information for two or more caregivers, the caregiver profile information including one or more of schedule information, resource information, relationship information, or location information for individual caregivers, the caregiver profile information including first caregiver profile information stored in a first caregiver profile for a first caregiver and second caregiver profile information stored in a second caregiver profile for a second caregiver;
means for obtaining activity tasks about the care recipient, the activity tasks determined based on the care recipient profile, the activity tasks performed to care for the care recipient, the activity tasks having associated activity information, the activity information indicating one or more of an estimated time commitment, an activity task type, or required caregiver resources for a given activity task, the activity tasks including a first activity task having first activity information and a second activity task having second activity information;
means for generating a queue of activity tasks for the care recipient based on the activity information and the care recipient profile;
means for determining likelihood metric values for the individual caregivers and the activity tasks in the queue, the likelihood metric value for a given caregiver and a given activity task indicating capacity and/or likelihood of the given caregiver to perform the given activity task, the likelihood metric values being determined based on activity information for the individual activity tasks and the profile information in the individual caregiver profiles, the likelihood metric values including a first likelihood metric value for the first caregiver and the first action task, and a second likelihood metric value for the second caregiver and the first action task; and
responsive to the likelihood metric values indicating that the individual caregiver has the capacity and/or likelihood to complete the individual activity task, means for communicating the individual activity task to the individual caregiver such that, responsive to the first activity information, the first caregiver profile information, and the first likelihood metric values indicating that the first caregiver has the capacity and/or likelihood to complete the first activity task, the first activity task is communicated to first caregiver, and, responsive to the second activity information, the second caregiver profile information, and the second likelihood metric values indicating that the second caregiver has the capacity and/or likelihood to complete the second activity task, the second activity task is communicated to the second caregiver.

14. The system of claim 13, wherein the means for storing caregiver profile information includes location information in the caregiver profiles such as, static and dynamic location information, the static location information indicating a location of a caregiver's residence in relation to a residence of the care recipient, the dynamic location information indicating a caregiver's current location relative to the residence of the care recipient.

15. The system of claim 13, wherein the means for storing caregiver profile information includes historical information indicating previous care provided by a caregiver to the care recipient.

16. The system of claim 13, wherein the means for generating a queue of activity tasks for the care recipient are based on information obtained from health sensor output signals that convey information related to a physical condition of the care recipient, and generate the activity tasks and the activity task queue based on the output signals.

17. The system of claim 13, wherein means for determining likelihood metric values for the individual caregivers is configured such that the activity task type indicates whether an activity task should be performed by one or more of a family member, a friend, or a medical professional.

18. The system of claim 13, wherein means for communicating the individual activity task to the individual caregiver is configured such that one or more of the activity tasks requests are generated manually by a caregiver based on caregiver monitoring and/or observation of the care recipient.
